(19) United States
(12) Patent Application Publication
(10) Pub. No.: US 2013/0027538 A1
(43) Pub. Date: Jan. 31, 2013

(54) MULTI-REGION FOCUS NAVIGATION INTERFACE

(71) Applicants: Yuhua Ding, Bothell, WA (US); Shannon Roy Campbell, Woodinville, WA (US)

(72) Inventors: Yuhua Ding, Bothell, WA (US); Shannon Roy Campbell, Woodinville, WA (US)

(73) Assignee: MITUTOYO CORPORATION, Kawasaki-shi (JP)

(21) Appl. No.: 13/194,856

(22) Filed: Jul. 29, 2011

(51) Int. Cl. H04N 7/18; G03B 13/00

(52) U.S. Cl. 348/79; 382/100; 348/E07.085

(57) ABSTRACT

A multi-region focus navigation interface for a machine vision inspection system is provided to assist a user with user-directed or manual focus operations. The multi-region focus navigation interface comprises a plurality of regional focus elements, each corresponding to a respective region of interest and superimposed on a displayed field of view. Each focus element comprises at least first and second operating states corresponding to its focus distance being in a close or intermediate range, respectively. Each operating state comprises a respective graphical focus indicator. For the intermediate range, a focus improvement direction may also be indicated. In one embodiment, in the close range operating state, a user may activate a region focus element to perform autofocus operations, while in the intermediate range operating state, a user may activate a focus element to perform operations that move toward the focus height by a predetermined step size.

### FIELD OF THE INVENTION

The invention relates generally to machine vision inspection systems, and more particularly to systems and methods for an interface that assists a user in focusing a machine vision inspection system.

### BACKGROUND OF THE INVENTION

Precision machine vision inspection systems (or “vision systems” for short) can be utilized to obtain precise dimensional measurements of inspected objects and to inspect various other object characteristics. Such systems may include a computer, a camera and optical system, and a precision stage that is movable in multiple directions to allow workpiece inspection. One exemplary prior art system that can be characterized as a general-purpose “off-line” precision vision system is the commercially available QUICK VISION® series of PC-based vision systems and QVPAK® software available from Mitutoyo America Corporation (MAC), located in Aurora, Ill. The features and operation of the QUICK VISION® series of vision systems and the QVPAK® software are generally described, for example, in the QVPAK 3D CNC Vision Measuring Machine User's Guide, published January 2003, and the QVPAK 3D CNC Vision Measuring Machine Operation Guide, published September 1996, each of which is hereby incorporated by reference in their entirety. This type of system is able to use a microscope-type optical system and move the stage so as to provide inspection images of either small or relatively large workpieces at various magnifications.

General purpose precision machine vision inspection systems, such as the QUICK VISION™ system, are also generally programmable to provide automated video inspection. Such systems typically include GUI features and predefined image analysis “video tools” such that operation and programming can be performed by “non-expert” operators. For example, U.S. Pat. No. 6,542,180, which is incorporated herein by reference in its entirety, teaches a vision system that uses automated video inspection including the use of various video tools. Although such systems may be used to perform automatic operations, they may also be used in a manual mode, for general-purpose microscopic examination. In addition, automatic inspection of a particular type of workpiece is accomplished by using the “learn mode” of such systems to image a representative workpiece, and define and record the operations of a part program that will be subsequently used to automatically inspect similar workpieces. A user may perform a large number of manual operations, including focusing operations, while navigating around a representative workpiece during learn mode.

Focusing when using a microscopic imaging system may be a frequent and tedious operation. This is particularly true when inspecting typical industrial workpieces (e.g., circuit assemblies boards, 3D molded parts, and the like), which may extend over a range along the focus axis which is much greater than the range associated with a typical biological microscope slide, or the like. When a user attempts to manually focus a microscope vision system, one issue that can arise is that it may be unclear in which direction to alter the focus in order to improve it. Furthermore, when a region is far from its focus height, small adjustments to the focus may not create a change in focus that is discernable by a user, leading to uncertainty, hesitation, and wasted time regarding whether to change direction or not, in order to focus. Furthermore, when a region is close to focus, small adjustments to the focus may not create a change in focus that is discernable by a user, leading to uncertainty, hesitation, and wasted time with regarding whether to stop focusing or not.

In contrast, quantitiative image analysis (e.g., contrast analysis) may reveal subtle changes in focus, and detect the direction that improves focus. It is known to use autofocus methods and autofocus video tools to assist with focusing a machine vision system. For example, the previously cited QVPAK® software includes such methods and autofocus video tools. Autofocusing is also discussed in “Robust Autofocusing in Microscopy,” by Jan-Mark Geusebroek and Arnold Smeulders in ISIS Technical Report Series, Vol. 17, November 2000, in U.S. Pat. No. 5,790,710, and in commonly assigned U.S. Pat. No. 7,030,351, and commonly assigned U.S. Patent Publication No. 20100158343, each of which is incorporated herein by reference, in its entirety. In one known method of autofocusing, the camera moves through a range of positions or imaging heights along a Z-axis and captures an image at each position (referred to as an image stack). For a desired region of interest in each captured image, a focus metric (e.g., a contrast metric) is calculated and related to the corresponding position of the camera along the Z-axis at the time that the image was captured. A focus curve based in this data, that is a curve that plots the contrast metric value as a function Z height, exhibits a peak at the best focus height (simply referred to as the focus height). A curve may be fit to the data to estimate the focus height with a resolution that is better than the spacing between Z heights of the data points. However, automated autofocus tools take time to acquire an image stack, which may make known autofocus methods and tools inconvenient to use at many times during general purpose manual navigation and inspection of a workpiece.

Compufocus™, available from RAM Optical Instrumentation of Rochester, N.Y., USA, provides a known user interface for assisting manual focus operations. Briefly, the user uses a mouse to draw an outline around the feature which is desired to be focused on (the region of interest). The associated user interface then displays a “slider bar” to the right of the image display window with a double headed arrow located at its center. The user then moves the stage up or down (at their discretion) until the double-headed arrow (which apparently slides corresponding to the stage move) changes to a single arrow aligned with the bar (the arrow apparently indicating that the direction for improved focus has been detected). The user then moves the stage in the direction of the arrow (up or down) until the arrow points transverse to the bar and a green square appears at the center of the bar. The green square apparently indicates that the best focus position has been estimated (perhaps based on focus curve data obtained during the additional user-directed stage movement). The user then moves the stage until the transverse-pointing arrow aligns with the green square (which may be flashing), which indicates that the best focus position has been attained.

Facilitating focusing for a manual user of a machine vision system may be an important aspect of machine vision inspection system operation, and even small improvements in ease of use or convenience may be of great value. Thus, a system that could further simplify and improve the convenient and accurate user-directed focusing during the workpiece navigation operations of typical manual inspection and/or learn mode operations of a general purpose machine vision inspection system, would be desirable.

### SUMMARY OF THE INVENTION

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The previously outlined Compufocus™ system and user interface fails to provide the degree of convenience, intuitive operation, and ease-of-use desired by many users. For example, the Compufocus™ user interface outlined above is not configured to suggest to the user the direction that provides improved focus until the user creates a region of interest, guesses an improvement direction, and manually provides motion to support the operation of the Compufocus™ system. Furthermore, it is simply an “indicator” system. That is, it does not have an integrated motion control and/or autofocus capability that can be activated from within the user interface that provides the indicator. Furthermore, it is related to a single region of interest, and does not allow a user to intuitively recognize the overall topography of the workpiece that is in the displayed field of view. Thus, it does not facilitate intuitive navigation and focusing over the full field of view.

The multi-region focus navigation interface disclosed herein remedies all of the aforementioned shortcomings, and provides additional benefits in terms of convenience, intuitive operation, and ease-of-use. In accordance with one aspect of the invention, a multi-region focus navigation interface for a machine vision inspection system is provided. In one embodiment, the multi-region focus navigation interface comprises a plurality of regional focus elements, each corresponding to a respective region of interest in a field of view of the machine vision inspection system and superimposed on an image of the field of view. The plurality of regional focus elements are simultaneously displayed on the image of the field of view at locations corresponding to their respective regions of interest. Each regional focus element comprises a graphical focus indicator which is indicative of a focus distance for the current image height relative to a focus height corresponding to its respective region of interest on the workpiece surface.

In accordance with another aspect of the invention, in one embodiment each regional focus element comprises at least a first operating state corresponding to the focus distance being in a close range, and a second operating state corresponding to the focus distance being in an intermediate range that extends farther from the focus height than the close range. The first operating state comprises a first type of graphical focus indicator which is indicative that the focus distance is in the close range. The second operating state comprises a second type of graphical focus indicator which is indicative of both a focus improvement direction and that the focus distance is in the intermediate range. In one embodiment, the second type of graphical focus indicator may comprise an arrow which is oriented to indicate the focus improvement direction.

In accordance with another aspect of the invention, in one embodiment the first operating state further comprises a first-state set of focus operations that are activated when a user uses an input device to provide a corresponding activation of the focus element during the first operating state. In one embodiment, the first-state set of focus operations include autofocus operations that automatically move to the focus height based on acquiring and analyzing an image stack.

In accordance with another aspect of the invention, in one embodiment the second operating state further comprises a second-state set of focus operations that are activated when a user uses an input device to provide a corresponding activation of the focus element during the second operating state. In one embodiment, the second-state set of focus operations include operations that move toward the focus height by a predetermined step size.

In accordance with another aspect of the invention, in one embodiment the second operating state further comprises an extended second-state set of focus operations that are activated when a user uses an input device to provide a corresponding activation of the focus element during the second operating state, the extended second-state set of focus operations comprising operations that move toward the focus height by a predetermined step size followed by autofocus operations that automatically move to the focus height based on acquiring and analyzing an image stack.

In one embodiment, the second-state set of focus operations are activated by a first type of user input device activation (e.g., a single mouse click), and the extended second-state set of focus operations are activated by a second type of user input device activation (e.g., a double mouse click).

In accordance with another aspect of the invention, in one embodiment each regional focus element is configured to be activated by the user positioning a cursor of the multi-region focus navigation interface proximate to the corresponding graphical focus indicator and entering an activation signal using the input device. In one embodiment, the activation signal may be a mouse click.

In accordance with another aspect of the invention, in one embodiment each regional focus element comprises a third operating state corresponding to the focus distance being in a far range that extends farther from the focus height than the intermediate range. In one embodiment, the third operating state comprises a third type of graphical focus indicator which is indicative of a focus improvement direction and that the focus distance is in the far range. In one embodiment, the far range may extend at least plus or minus 15 times the depth of field of the imaging system used to image the field of view, from the focal height.

In accordance with another aspect of the invention, in one embodiment the third operating state further comprises a third-state set of focus operations that are activated when a user uses an input device to provide a corresponding activation of the focus element during the third operating state. In one embodiment, the third-state set of focus operations comprise operations that move toward the focus height by a predetermined step size.

In accordance with another aspect of the invention, in one embodiment the third operating state further comprises an extended third-state set of focus operations that are activated when a user uses an input device to provide a corresponding activation of the focus element during the third operating state, the extended third-state set of focus operations comprising operations that move toward the focus height by a predetermined step size followed by autofocus operations that automatically move to the focus height based on acquiring and analyzing an image stack. In one embodiment, the third-state set of focus operations are activated by a first type of user input device activation (e.g., a single mouse click), and the extended third-state set of focus operations are activated by a second type of user input device activation (e.g., a double mouse click).

In one embodiment, when the region of interest is beyond the far range or the focus distance and/or direction is not known for that region of interest (e.g., due to inadequate focus curve data for that region of interest), the regional focus element comprises a fourth operating state including a fourth type of graphical focus indicator which indicates that the focus distance is beyond the far range, or the focus distance and/or direction is not known.

In accordance with another aspect of the invention, in one embodiment the plurality of regional focus elements comprises at least a minimum number (e.g., 3, 5, 9, etc.) of regional focus elements. In one embodiment, the plurality of regional focus elements comprises at least three regional focus elements spaced apart along a first direction. In another embodiment, the plurality of regional focus elements may comprise at least five regional focus elements including three regional focus elements spaced apart along a first direction and three regional focus elements spaced apart along a second direction that is transverse to the first direction.

In accordance with another aspect of the invention, in one embodiment the multi-region focus navigation interface is configured such that when the field of view is moved relative to a workpiece surface, each regional focus element is moved to follow its corresponding region of interest in the image of the field of view. In addition, in one embodiment, when the field of view is moved by a sufficient distance, a new regional focus element is automatically generated for the plurality of regional focus elements, the new regional focus element corresponding to a new region of interest in the image of the field of view.

In accordance with another aspect of the invention, in one embodiment regional focus elements are automatically placed at default locations in the field of view. In accordance with another aspect of the invention, in one embodiment regional focus elements may be configured to include operations comprising at least one of: (a) operations responsive to user input for changing the location of a regional focus element and its corresponding region of interest relative to the image of the field of view; and (b) operations responsive to user input for eliminating a regional focus element from an image of the field of view.

It will be appreciated that the aforementioned features may be supported by accumulating focus curve data, or based on known depth from defocus methods, or the like, for various regions of interest during the normal manual operations of a machine vision inspection system. Thus, the aforementioned features may be supported “continuously” and in real time (at least for the most part), by operations that require no special procedures on the part of the user. It should be appreciated that in various embodiments, various combination of the features outlined above facilitate convenient, intuitive, and easy user-directed (e.g., manual) navigation and focusing over the full field of view.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a diagram showing various typical components of a general purpose precision machine vision inspection system;

FIG. 2 is a block diagram of a control system portion and a vision components portion of a machine vision inspection system similar to that of FIG. 1, and including features according to this invention;

FIG. 3 is a diagram of a graph illustrating a representative focus curve and related focus ranges;

FIG. 4 is a diagram illustrating various features of one embodiment of a user interface display including a multi-region focus navigation interface;

FIG. 5 is a diagram illustrating the user interface display of FIG. 4 after a shift in position of the field of view has been made;

FIG. 6 is a flow diagram illustrating one embodiment of a general routine for operating a multi-region focus navigation interface for a machine vision inspection system; and

FIG. 7 is a flow diagram illustrating one embodiment of a general routine for implementing focus control operations associated with the operation of regional focus elements in a multi-region focus navigation interface for a machine vision inspection system.

### DETAILED DESCRIPTION OF THE PREFERRED EMBODIMENT

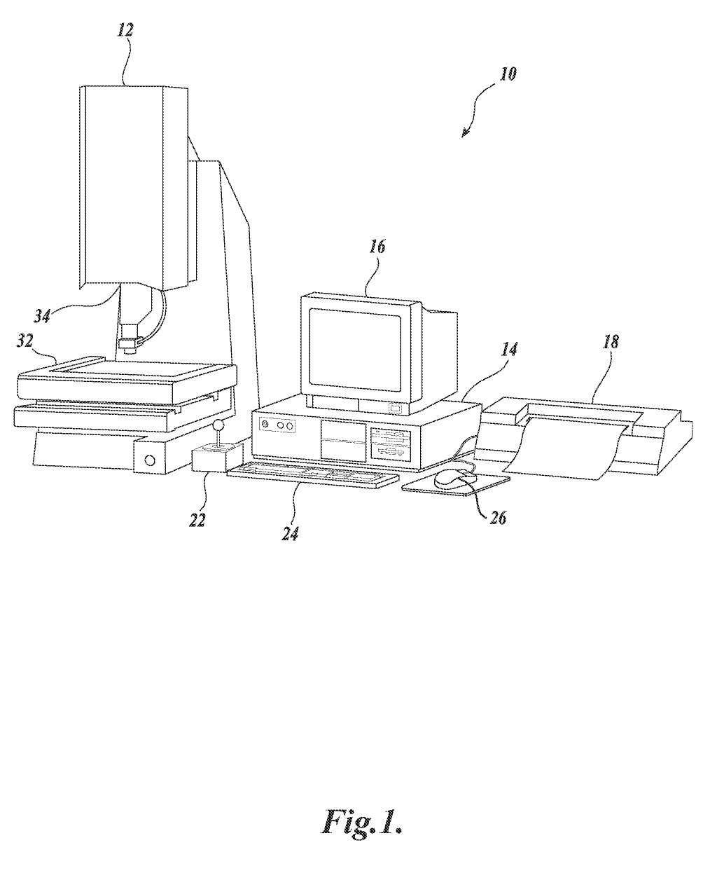

FIG. 1 is a block diagram of one exemplary machine vision inspection system 10 usable in accordance with methods described herein. The machine vision inspection system 10 includes a vision measuring machine 12 that is operably connected to exchange data and control signals with a controlling computer system 14. The controlling computer system 14 is further operably connected to exchange data and control signals with a monitor or display 16, a printer 18, a joystick 22, a keyboard 24, and a mouse 26. The monitor or display 16 may display a user interface suitable for controlling and/or programming the operations of the machine vision inspection system 10.

The vision measuring machine 12 includes a moveable workpiece stage 32 and an optical imaging system 34 which may include a zoom lens or interchangeable lenses. The zoom lens or interchangeable lenses generally provide various magnifications for the images provided by the optical imaging system 34. The machine vision inspection system 10 is generally comparable to the QUICK VISION® series of vision systems and the QVPAK® software discussed above, and similar state-of-the-art commercially available precision machine vision inspection systems. The machine vision inspection system 10 is also described in commonly assigned U.S. Pat. Nos. 7,454,053, 7,324,682, U.S. patent application Ser. Nos. 12/343,383, filed Dec. 23, 2008, and Ser. No. 12/608,943, filed Oct. 29, 2009, which are each incorporated herein by reference in their entireties.

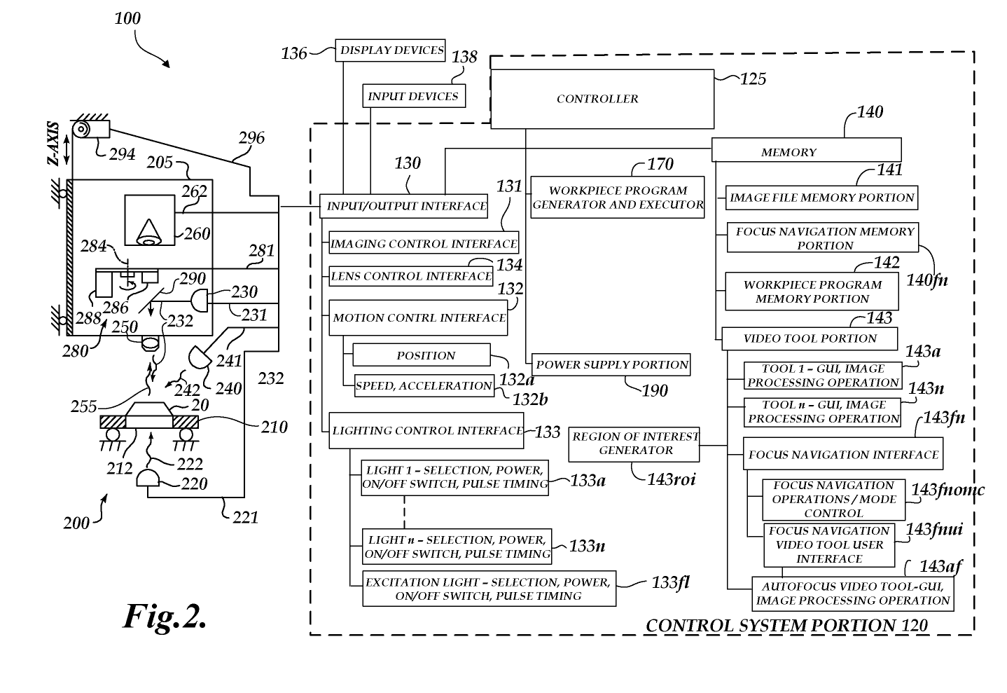

FIG. 2 is a block diagram of a control system portion 120 and a vision components portion 200 of a machine vision inspection system 100 similar to the machine vision inspection system of FIG. 1, and including features according to this invention. As will be described in more detail below, the control system portion 120 is utilized to control the vision components portion 200. The vision components portion 200 includes an optical assembly portion 205, light sources 220, 230, 230′, and 240, and a workpiece stage 210 having a central transparent portion 212. The workpiece stage 210 is controllably movable along X and Y axes that lie in a plane that is generally parallel to the surface of the stage where a workpiece 20 may be positioned.

The optical assembly portion 205 includes a camera system 260, an interchangeable objective lens 250, and may include a turret lens assembly 280 having lenses 286 and 288. Alternatively to the turret lens assembly, a fixed or manually interchangeable magnification-altering lens, or a zoom lens configuration, or the like, may be included.

The optical assembly portion 205 is controllably movable along a Z-axis that is generally orthogonal to the X and Y axes, by using a controllable motor 294 that drives an actuator to move the optical assembly portion 205 along the Z-axis to change the focus of the image of the workpiece 20. The controllable motor 294 is connected to the input/output interface 130 via a signal line 296.

A workpiece 20, or a tray or fixture holding a plurality of workpieces 20, which is to be imaged using the machine vision inspection system 100 is placed on the workpiece stage 210. The workpiece stage 210 may be controlled to move relative to the optical assembly portion 205, such that the interchangeable objective lens 250 moves between locations on a workpiece 20, and/or among a plurality of workpieces 20. One or more of a stage light 220, a coaxial light 230, and a surface light 240 (e.g., a ring light) may emit source light 222, 232, and/or 242, respectively, to illuminate the workpiece or workpieces 20. The light source 230 may emit light 232 along a path including a minor 290. The source light is reflected or transmitted as workpiece light 255, and the workpiece light used for imaging passes through the interchangeable objective lens 250 and the turret lens assembly 280 and is gathered by the camera system 260. The image of the workpiece(s) 20, captured by the camera system 260, is output on a signal line 262 to the control system portion 120. The light sources 220, 230, and 240 may be connected to the control system portion 120 through signal lines or busses 221, 231, and 241, respectively. To alter the image magnification, the control system portion 120 may rotate the turret lens assembly 280 along axis 284 to select a turret lens, through a signal line or bus 281.

As shown in FIG. 2, in various exemplary embodiments, the control system portion 120 includes a controller 125, the input/output interface 130, a memory 140, a workpiece program generator and executor 170, and a power supply portion 190. Each of these components, as well as the additional components described below, may be interconnected by one or more data/control buses and/or application programming interfaces, or by direct connections between the various elements.

The input/output interface 130 includes an imaging control interface 131, a motion control interface 132, a lighting control interface 133, and a lens control interface 134. The motion control interface 132 may include a position control element 132a, and a speed/acceleration control element 132b although such elements may be merged and/or indistinguishable. The lighting control interface 133 includes lighting control elements 133a-133n, and 133fl which control, for example, the selection, power, on/off switch, and strobe pulse timing if applicable, for the various corresponding light sources of the machine vision inspection system 100.

The memory 140 may include an image file memory portion 141, a focus navigation memory portion 140fn described in greater detail below, a workpiece program memory portion 142 that may include one or more part programs, or the like, and a video tool portion 143. The video tool portion 143 includes video tool portion 143a and other video tool portions (e.g., 143n), which determine the GUI, image processing operation, etc., for each of the corresponding video tools, and a region of interest (ROI) generator 143roi that supports automatic, semi-automatic and/or manual operations that define various ROIs that are operable in various video tools included in the video tool portion 143.

In the context of this disclosure, and as known by one of ordinary skill in the art, the term video tool generally refers to a relatively complex set of automatic or programmed operations that a machine vision user can implement through a relatively simple user interface (e.g., a graphical user interface, editable parameter windows, menus, and the like), without creating the step-by-step sequence of operations included in the video tool or resorting to a generalized text-based programming language, or the like. For example, a video tool may include a complex pre-programmed set of image processing operations and computations which are applied and customized in a particular instance by adjusting a few variables or parameters that govern the operations and computations. In addition to the underlying operations and computations, the video tool comprises the user interface that allows the user to adjust those parameters for a particular instance of the video tool. For example, many machine vision video tools allow a user to configure a graphical region of interest (ROI) indicator through simple “handle dragging” operations using a mouse, in order to define the location parameters of a subset of an image that is to be analyzed by the image procession operations of a particular instance of a video tool. It should be noted that the visible user interface features are sometimes referred to as the video tool, with the underlying operations being included implicitly.

In common with many video tools, the multi-region focus navigation subject matter of this disclosure includes both user interface features and underlying image processing operations, and the like, and the related features may be characterized as features of a focus navigation video tool 143fn included in the video tool portion 143. However, the majority of video tools are implemented for a particular instance of analysis in relation to a particular feature or region of interest, perform their function, and then cease operation. In contrast, it will be appreciated that in some embodiments the multi-region focus navigation features disclosed here may be applied globally to aid user-directed (e.g., manual) navigation throughout a field of view, and may generally persist and continue to operate during user-directed navigation, until they are explicitly terminated by a user. A user may experience the features of the focus navigation video tool 143fn described below primarily as an operating mode and/or a user interface, rather than as a conventional video tool. Thus, it should be appreciated that characterizing the multi-region focus navigation subject matter of this disclosure as a video tool in the following description is matter of choice for description, and it is not intended to be limiting with regard to its appearance to the user, or its manner of implementation. One of ordinary skill in the art will appreciate that the circuits and routines underlying the multi-region focus navigation features disclosed herein may be implemented as distinct elements related to a distinct operating mode or user interface, in some embodiments.

Briefly, as will be described in more detail below, in one embodiment the focus navigation video tool 143fn may act as a visual assistant to assist a user with a user-directed or manual focus operation for a machine vision system 100. In certain implementations, the focus navigation video tool 143fn may, for a plurality of regions of interest within a field of view, automatically qualitatively indicate a focal distance to a best focus height during a user-directed or manual workpiece focus and/or navigation operations. The focus navigation video tool 143fn thus helps expedite the manual focus process and thus improves the ease-of-use of the machine vision system 100.

In one embodiment, the focus navigation video tool 143fn may include a portion that provides focus navigation operations/mode control 143fnomc and a portion that provides a focus navigation interface 143fnui (a user interface). Features and operations associated with these elements are described in greater detail below. Briefly, the focus navigation operations/mode control 143fnomc may perform operations (e.g., region of interest tracking, image analysis operations, and/or memory management), to configure and support operation of the focus navigation video tool or tool modes as described in greater detail below.

In one embodiment, the focus navigation video tool 143fn may also be linked or otherwise act in conjunction with certain known autofocus tools or operations (e.g., region of interest contrast computations, focus curve data determination and storage, focus curve peak finding, etc.), which may be included in an autofocus video tool 143af of the video tool portion 143. As an example of how the operations may be linked, in one embodiment, once a region of interest of the focus navigation video tool 143fn is “close” to being in focus, it may be activated by a user to call a sub-portion of the operations of the autofocus video tool 143af to acquire and analyze a stack of images and move to the resulting best focus height. As another example, known portions of autofocus tool operations may be used as directed by the focus navigation operations/mode control 143fnomc for storing data acquired images in relation to their associated Z heights (as determined based on motion control sensor data and the like), and analyzing that data and storing the results to construct and analyze focus curve data to find a best focus height and/or a focus distance to the best focus height. The focus navigation operations/mode control 143fnomc may cause the foregoing operations to be performed continuously (e.g., to provide continuously updated focus information for its regions of interest) for the sequence of live images that are normally acquired and displayed during user-directed manual and/or learn mode operations.

Alternative configurations are possible for the focus navigation video tool 143fn. For example, in certain implementations, the focus navigation operations/mode control 143fnomc may be utilized to implement a focus navigation mode (as opposed to a separate tool). More generally, this invention may be implemented in any now known or later-developed form that is operable in conjunction with the machine vision inspection system 100 to provide the features disclosed herein in relation to the focus navigation operations.

In general, the memory portion 140 stores data usable to operate the vision system components portion 200 to capture or acquire an image of the workpiece 20 such that the acquired image of the workpiece 20 has desired image characteristics. The focus navigation memory portion 140fn may be controlled by the focus navigation operations/mode control 143fnomc to store and/or recall the various data used by the focus navigation video tool 143fn. The memory portion 140 may also contain data defining a graphical user interface operable through the input/output interface 130. The memory portion 140 may also store inspection result data, may further store data usable to operate the machine vision inspection system 100 to perform various inspection and measurement operations on the acquired images (e.g., implemented, in part, as video tools), either manually or automatically, and to output the results through the input/output interface 130.

The signal lines or busses 221, 231, and 241 of the stage light 220, the coaxial lights 230 and 230′, and the surface light 240, respectively, are all connected to the input/output interface 130. The signal line 262 from the camera system 260 and the signal line 296 from the controllable motor 294 are connected to the input/output interface 130. In addition to carrying image data, the signal line 262 may carry a signal from the controller 125 that initiates image acquisition.

One or more display devices 136 (e.g., the display 16 of FIG. 1) and one or more input devices 138 (e.g., the joystick 22, keyboard 24, and mouse 26 of FIG. 1) can also be connected to the input/output interface 130. The display devices 136 and input devices 138 can be used to display a user interface, which may include various graphical user interface (GUI) features that are usable to perform inspection operations, and/or to create and/or modify part programs, to view the images captured by the camera system 260, and/or to directly control the vision system components portion 200. The display devices 136 may display user interface features associated with the focus navigation interface 143fnui, described in greater detail below.

In various exemplary embodiments, when a user utilizes the machine vision inspection system 100 to create a part program for the workpiece 20, the user generates part program instructions by operating the machine vision inspection system 100 in a learn mode to provide a desired image acquisition training sequence. For example a training sequence may comprise positioning a particular workpiece feature of a representative workpiece in the field of view (FOV), setting light levels, focusing or autofocusing, acquiring an image, and providing an inspection training sequence applied to the image (e.g., using an instance of one of the video tools on that workpiece feature). The learn mode operates such that the sequence(s) are captured or recorded and converted to corresponding part program instructions. These instructions, when the part program is executed, will cause the machine vision inspection system to reproduce the trained image acquisition and inspection operations to automatically inspect that particular workpiece feature (that is the corresponding feature in the corresponding location) on a run mode workpiece or workpieces which matches the representative workpiece used when creating the part program.

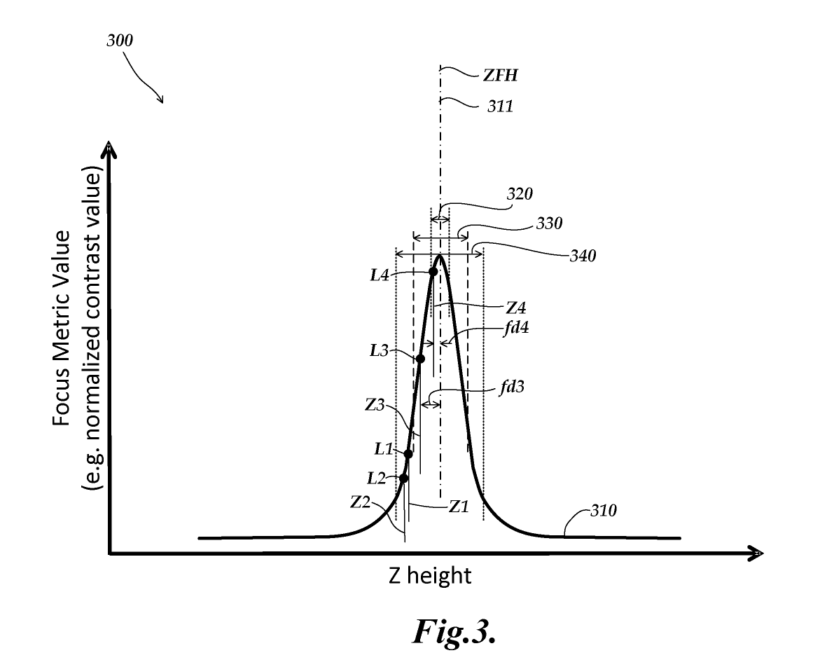

FIG. 3 is a diagram of a graph 300 illustrating a representative focus curve 310. Exemplary techniques for the determination and analysis of focus curves are taught in U.S. Pat. No. 6,542,180, which is hereby incorporated herein by reference in its entirety. In certain known systems, when a focus curve is to be determined or estimated for an ROI, for each captured image, a focus metric value is calculated for the ROI and paired with the corresponding Z position of the camera at the time that image was captured, to provide data points (coordinates) that define the focus curve. In certain systems, the focus metric may involve a calculation of the contrast or sharpness of the region of interest in an image. Various focus metrics are described in detail in the incorporated '180 patent, and various suitable focus value functions will also be known to one of ordinary skill in the art, including focus value functions which are based on alternatives to contrast-based focus metrics. Thus, such functions will not be further described.

As is generally known, the shape of a focus curve depends on a number of factors, such as the type of surface (e.g., shape, texture, etc.), the depth of field, the size of the region of interest (e.g., a larger region of interest may correspond to less noise in the focus metric data), lighting conditions, etc. The focus metric values on the Y-axis of FIG. 3 generally correspond to the quality of the focus of a feature included in a region of interest of a corresponding image. A focus value higher on the Y-axis corresponds to better focus. Thus, a best focus position corresponds to the peak of the focus curve (e.g., the peak focus Z height 311), as will be described in more detail below. A focus curve is often approximately symmetric and resembles a bell curve.

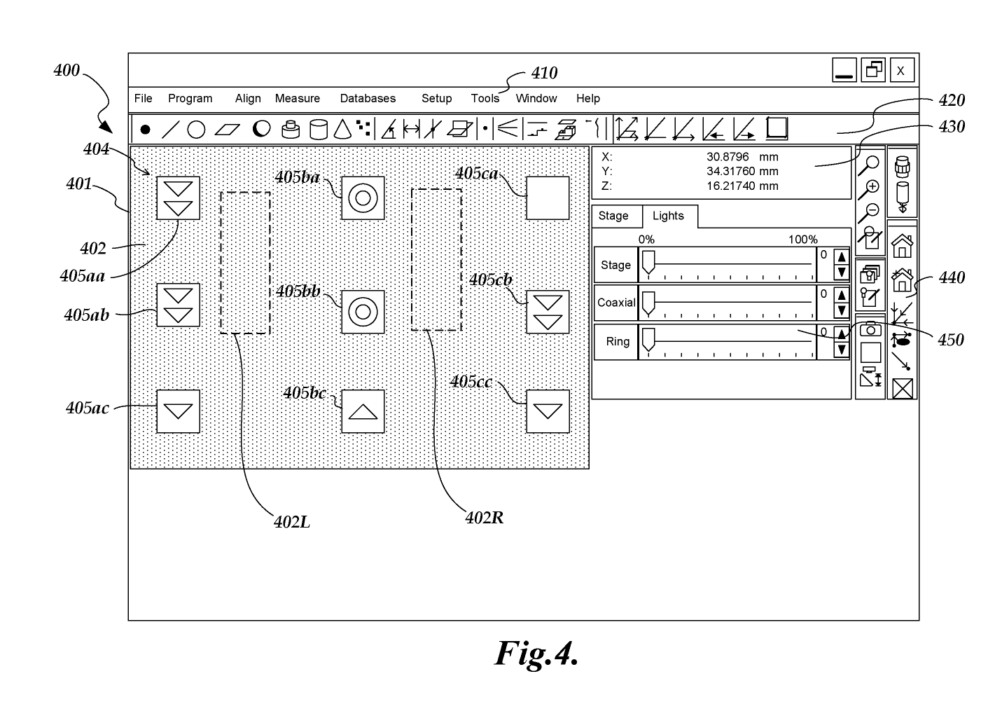

As will be described in more detail below, in accordance with the present invention, a focus navigation video tool (e.g., focus navigation video tool 143fn of FIG. 2) is provided which utilizes estimated positions on a focus curve (e.g., focus curve 310) in order to support a user interface (e.g., the focus navigation interface 143fnui) that assists a user with navigation and user-directed focus operations. As will be described in more detail below with respect to FIG. 4, in one embodiment the focus navigation video tool provides indications of estimated focus distances for a plurality of regions of interest in a field of view. With reference to the ranges illustrated in FIG. 3, the estimated focus distances are generally categorized as being in either a close range 320, an intermediate range 330 or a far range 340, which are each illustrated as being progressively further from the focus height 311 on the focus curve 310. In certain embodiments, the close range 320, intermediate range 330, and far range 340 may be tied to specific distances. In one specific example embodiment, the distances may be based on a certain number of depth-of-field (DOF) increments (e.g., the close range being within SDOF, the intermediate range being between SDOF and 15DOF, and the far range being greater than 15 DOF). It will be appreciated that while for purposes of simplicity the far range 340 has been illustrated in FIG. 3 as comprising a range with set limits, in certain embodiments the far range may be defined as comprising any distance beyond a specified value (e.g., any distance beyond the limits of the intermediate range). In addition, in certain embodiments additional ranges may also be added. In certain embodiments, more qualitative definitions may be applied (e.g., the far range corresponding to a distance at which an autofocus process is likely to fail, and the close range corresponding to a distance at which there is a high degree of certainty that an autofocus process will be successful).

An illustrative estimation of a focus distance with respect to the focus curve 310 can be explained in part by the following example process. It will be understood that a focus curve may be determined for each of the plurality of regions of interest associated with the focus navigation video tool 143fn. It will be appreciated that the following example is intended to be illustrative only and not limiting. In this example, it is assumed that the process begins at a first image height (Z height) which produces a first contrast value L1 as shown on the focus curve 310. At this point, the process has only a single contrast value, not enough values to estimate a focus curve, and so is not able to provide an indication of a focus height or focus distance. (In one embodiment, under these conditions, the focus navigation interface 143fnui may display the empty regional focus element 405ca of FIG. 4, as will be described in more detail below.)

As the user continues to navigate around the workpiece, a second image is captured at a second image height which produces a second contrast value L2 as shown on the focus curve 310. Since the contrast value L2 is lower on the focus curve than the contrast value L1 of the first location, the process determines that the direction for improved focus points from the second image height Z2 toward the first image height Z1. However, since the contrast values are so low, perhaps the location of the focus height cannot be determined with a desired accuracy, and so an indication may be provided that the focus distance is estimated to be “far away” or at an unknown focal distance, but a focus direction may be indicated (e.g., see double upward pointing arrow of regional focus element 405cb of FIG. 4, as will be described in more detail below).

If the user wishes to better focus the region of interest corresponding to the focus curve 310, the user may move the camera in the indicated direction for improved focus. A third image is captured at a third image height Z3 which produces a third contrast value L3 as shown on the focus curve 310. Using the contrast values L1, L2, and L3, the algorithm may estimate a rough peak location (focus height) ZFH from the fitted curve. In some embodiments, estimating a peak location may be based on curve parameters that are related to the depth of field (DOF) of the imaging system, in that the width of the curve (in terms of Z) depends at least partly on that DOF. In various embodiments, it may be convenient to characterize distances along the Z axis, including the various ranges 320-340, and certain predetermined step sizes described below, in terms of “DOF units”. Once the focus height ZFH has been estimated, the limits of the standard ranges such as the close range 320, the intermediate range 330, and the far range 340 may be estimated. For example, these limits may be established at a predetermined number of DOF units from the focus height ZFH (e.g., in one embodiment, +/−10 DOF for far range 340, +/−5 DOF for intermediate range 330, and +/−2 DOF for close range 320). This may allow the same processes and/or routines to be applied to a variety of imaging configurations with little or no change.

In this particular example, for the third contrast value L3 the peak location or focus height 311 is estimated to be at a focal distance fd3 (=ZFH−Z3) from the image height Z3, which falls in the intermediate range 330. In such a circumstance, the focus region element for the corresponding ROI may display an indication that the focus position is estimated to be in an intermediate range (e.g., see single upward pointing arrow of regional focus element 405bc of FIG. 4, as will be described in more detail below).

If the user wishes to better focus the region of interest corresponding to the focus curve 310, the user may move the camera in the indicated direction for improved focus. A fourth image is captured at a fourth image height Z4 which produces a fourth contrast value L4 as shown on the focus curve 310. Using the contrast values L1, L2, L3, and L4, the algorithm may estimate a peak location (focus height) ZFH using some form of interpolation or curve fitting. In this particular example, for the fourth contrast value L4 the peak location or focus height 311 is estimated to be at a focal distance fd4 (=ZFH−Z4) from the image height Z4, which falls in the close range 320. In such a circumstance, the focus region element for the corresponding ROI may display an indication that the image height Z4 is in the close range 320, or relatively close to the focus height (e.g., see concentric circles of regional focus element 405ba of FIG. 4, as will be described in more detail below).

It should be appreciated that the foregoing example is simplified to describe just a few image heights, for purposes of explanation. In various embodiments, with respect to the focus curve 310, the processes of the focus navigation video tool may be designed to continuously acquire and analyze images at any and all fields of view and Z heights visited by the user, continuously compute and update and store the related focus curve data. Thus, the focus curve 310 and the focus height 311 may be well estimated based on a large number of data points (e.g., corresponding to a standard live image update rate, for example), and reliably estimate the focus direction and focal distance over a large range relative to the focus height 311. In one implementation, the processes are intended to provide a real-time guide to the user-directed navigation and focus operations, for which computational speed, robustness to lighting/stage speed, search range, and being able to handle a wide variety of workpieces are key considerations.

In one embodiment, the focus navigation processes may utilize certain techniques similar to those described in U.S. Patent Publication No. 20100158343, which is commonly assigned and hereby incorporated by reference in its entirety. In various embodiments, the focus navigation processes do not have a learn mode, and the estimation of the defocus is primarily based on sampled contrast values using current and past images. In one specific implementation, the process stores contrast values for each ROI in each image, compares them with those of the previous images, and estimates the location of the focal height.

In one embodiment, the defocus is estimated by fitting a function with a general bell shape, such as a Gaussian function, to sampled contrast values. This works well when the sampled contrast values cover both sides of the contrast peak. However, if the sampled points are sparse and are at one side of the contrast peak, additional techniques may be utilized to provide more accurate estimates. For example, when the number of points for fitting increases, even if the data is from one side of the curve, the fitting may improve significantly. Thus, as more images become available, the prediction of the peak location may become more reliable. In addition, other techniques for estimating the focal position may also be utilized, such as computing the amount of blur from blurry images, and mapping the amount of blur to the axial defocus. Another technique is to monitor the contrast ratios between adjacent frames, and provide an indication when the ratio is above a predefined threshold, which indicates that the focus position is in the close range.

FIG. 4 is a diagram illustrating various features of one embodiment of a user interface display 400, including a multi-region focus navigation interface 404. It will be appreciated that the foregoing description of FIGS. 2 and 3 outlines various elements and operations that may be used to support the operation of the multi-region focus navigation interface 404. In the exemplary state shown in FIG. 4, the user interface display 400 includes a field of view window 401 that displays a workpiece image 402 and the multi-region focus navigation interface 404. As will be described in more detail below, the multi-region focus navigation interface 404 includes a plurality of regional focus elements 405aa, 405ab, 405ac, 405ba, 405bb, 405bc, 405ca, 405cb, and 405cc. The user interface display 400 also includes various measurement and/or operation selection bars such as the selection bars 420 and 440, a real-time X-Y-Z (position) coordinate window 430, and a light control window 450.

In various embodiments, the user may create a current instance of a multi-region focus navigation interface 404 by selecting a focus navigation video tool from a drop down menu or toolbar that displays a plurality of alternative video tools and/or mode selection buttons, all accessed under the tools menu element 410. Upon such a selection, in one embodiment, the user interface may automatically display the plurality of regional focus elements 405aa-405cc superimposed upon the current workpiece image 402 in the field of view window 401. In one embodiment, the regional focus elements 405aa-405cc may initially be placed at default locations corresponding to default ROI locations in the field of view 401. However, in various embodiments the operation of the regional focus elements 405 may be configured such that a user input may change the location of a regional focus element (e.g., by dragging its graphical indicator using an input device) and/or delete a regional focus element from the field of view window 401 (e.g., by right clicking on its graphical indicator and selecting “delete” or “hide” from a dropdown menu). In one embodiment, the multi-region focus navigation interface 404 may be disabled when a part program or other video tool is running. In various embodiments, alternative methods may be provided for a user to activate the multi-region focus navigation interface 404 (e.g., by pressing shortcut keys, by right-clicking in a video window and selecting the focus navigation video tool from a pop-up menu, etc.).

Each of the displayed plurality of regional focus elements 405aa-405cc corresponds to a respective region of interest in the field of view window 401, which may be adjacent to, or coincide with, its regional focus element 405. It may be noted that in various embodiments, for purposes of supporting general navigation and focus operations, it is not necessary that the regions of interest be explicitly indicated on the screen, since this tends to introduce distracting visual clutter. In certain embodiments, the regions of interest may be of fixed sizes (e.g., 50×50 pixels, etc.). In certain embodiments, the regions of interest may be a small default set of pixels proximate to a respective graphical indicator that may be used for focus operations. The number of the regional focus elements that are displayed may be set at a default value (e.g., 3, 5, 9, etc.), or may be designated by a user, and the layout of the regional focus elements may also be predetermined and/or selected and/or altered by a user, as outlined above. In certain embodiments, changing the location of a regional focus element automatically resets the associated data acquisition and analysis related to that regional focus element (e.g., as outlined relative to FIG. 3), since its associated ROI has been changed.

It should be appreciated that the utilization of a plurality of regional focus elements is particularly advantageous for 3D workpiece surfaces where focus direction and distance for different features on the workpiece surface may otherwise be difficult for a user to determine by simple observation (e.g., tilted or multi-component or stepped surfaces) and especially for curved surfaces.

In the embodiment shown in FIG. 4, for a 3D surface most of the regional focus elements 405aa-405cc include a graphical focus indicator which is indicative of a focus distance for the current image height relative to a focus height corresponding to its respective region of interest on the workpiece surface. For example, the regional focus elements 405ac and 405cc include a graphical focus indicator comprising a single downward pointing arrow, which is indicative that its focus distance to its focus height is in an intermediate range (e.g., in the range 330 of FIG. 3) in a downward direction. Similarly, the regional focus element 405bc includes a graphical focus indicator comprising a single upward pointing arrow, which is indicative that its focus distance to its focus height is in the intermediate range in an upward direction. An actual image of an FOV is not shown in FIG. 4. It will be understood that the image portion adjacent to the regional focus elements 405ac and 405cc would likely appear somewhat blurry, in an actual application.

As another example, the regional focus elements 405ba and 405bb each include a graphical focus indicator comprising two concentric circles, which is indicative that their focus distance to their focus heights is in a close range (e.g., in the range 320 of FIG. 3). An actual image of an FOV is not shown in FIG. 4. It will be understood that the image portion adjacent to the regional focus elements 405ba and 405bb would likely appear focused or nearly focused, in an actual application. In some embodiments, for regional focus elements corresponding to a close range a user may activate an autofocus operation by clicking on the respective regional focus element (e.g., the elements 405ba or 405bb).

As another example, the regional focus elements 405aa, 405ab, and 405cb each include a graphical focus indicator comprising downward pointing double arrows, which is indicative that their focus distance to their focus heights is in a far range (e.g., in the range 340 of FIG. 3), in a downward direction. More generally, they may point either up or down, depending on the estimated focus improvement direction. An actual image of an FOV is not shown in FIG. 4. It will be understood that the image portion adjacent to the regional focus elements 405aa, 405ab, and 405cb would likely appear to be quite blurry, in an actual application.

As another example, the regional focus element 405ca does not include a graphical focus indicator, which may indicate in certain embodiments that the system does not have an accurate enough estimation of the focus distance or direction for the region of interest which corresponds to the regional focus element 405ca. The user may learn that lack of an explicit graphical focus indicator (or an equivalent “unknown” indicator) may mean that such a regional focus element does not have enough image data to construct a focus curve, either because its focus distance is large (e.g., beyond the range 340 of FIG. 3), or it does not have enough images at a variety of Z heights to reliably estimate a focus peak. An actual image of an FOV is not shown in FIG. 4. It will be understood that the image portion adjacent to the regional focus element 405ca would likely appear to be the most blurry region, in an actual application.

As previously noted, displaying a plurality of regional focus elements (e.g., the focus elements 405aa-405cc) is particularly advantageous for 3D workpiece surfaces (e.g., tilted or multi-component or stepped surfaces) and especially for curved surfaces. In such cases the plurality of regional focus elements provides the user with an intuitive understanding of the general topography of the surface in the field of view. This allows the user to focus in the proper direction, and by a proper amount, at the locations of the regional focus elements, and importantly, also to intuitively understand the most likely focus direction and focus distance for locations between the regional focus elements throughout the field of view. This is a major advantage of the systems and methods disclosed herein.

For example, by viewing the interface shown in FIG. 4, the user would understand that the focus direction is down at both the left and right sides of the image, and the center of the image is approximately focused. From this the user may infer that the center is a “peak” and that the surface is curved down to the right and left of the peak. The user would also understand that the focus direction is most likely down in the image regions 402L and 402R because adjacent regional focus elements point downward. Also, by viewing the interface shown in FIG. 4, the user would understand that the focus distance is relatively farther down at the top of the image and farther up at the bottom of the image (e.g., all columns 405ax, 405bx, and 405cx indicate this same relationship). From this the user may infer that the surface slopes up as one moves from the top edge of the image toward the bottom edge of the image, and it is probably tilted, but not strongly curved, along this direction. Again, the user may infer focus directions and amounts throughout the image, not just at the regional focus elements, based on this information.

As will be described in more detail below, in certain embodiments the different graphical focus indicators may each correspond to a different operating state for the regional focus elements. Different operating states correspond to different respective focus distances, and/or an unknown focus distance. For example, the graphical focus indicator with two concentric circles may be displayed when a regional focus element is in a first operating state corresponding to the focus distance being in a close range. The graphical focus indicator with a single arrow (which is indicative of the focus improvement direction) may be displayed when a regional focus element is in a second operating state corresponding to the focus distance being in an intermediate range that extends farther from the focus height than the close range. Similarly, the graphical focus indicator with the double arrows may be displayed when a regional focus element is in a third operating state corresponding to the focus distance being in a far range that extends farther from the focus height than the intermediate range.

In one embodiment, the first operating state of a regional focus element further includes a first-state set of focus operations that may be activated when a user uses an input device (e.g., a mouse click) to provide a corresponding activation of the focus element during the first operating state. In one embodiment, the first-state set of focus operations include autofocus operations that automatically move to the focus height, based on acquiring and analyzing an image stack. In other words, in one specific example embodiment, when the graphical focus indicator with two concentric circles is displayed in a regional focus element (e.g., regional focus elements 405ba and 405bb), a user may click on the regional focus element to activate an autofocus operation. Such an autofocus operation may be quick and accurate, since it does not require the user to access a separate tool and/or redefine the region of interest, and the Z height range for the image stack may be small and well defined (requiring relatively few images to be acquired and analyzed).

In one embodiment, the second state of a regional focus element further includes a second-state set of focus operations that are activated when a user uses an input device to activate the regional focus element in a way that corresponds to the second-state set of focus operations. In one embodiment, the second-state set of focus operations includes operations that move toward the focus height by a predetermined step size when activated by user input. For example, in one specific embodiment, when the regional focus element is in the second state, corresponding to being in the intermediate range of focus distance, it may include a corresponding graphical focus indicator (e.g., a single arrow), and a user may single click on the regional focus element (e.g., on the graphical focus indicator) to activate an operation that moves toward the focus height by a predetermined step size. (e.g., a predetermined step size such as one or two times the depth of field of the imaging system, or one quarter of the intermediate range limit, or the like, in some embodiments). This allows the user to rapidly (and repeatedly, if desired) jog the focus by a useful amount relative to the region surrounding the particular regional focus element that is activated. In one embodiment, the second state of a regional focus element may further include an extended second-state set of focus operations that are activated when a user uses an input device to activate the regional focus element in a way that corresponds to the extended second-state set of focus operations. In one embodiment, the extended second-state set of focus operations includes executing the foregoing second-state set of focus operations, immediately and automatically followed by autofocus operations that move to the focus height based on acquiring and analyzing an image stack, when activated by an appropriate user input. For example, in one specific embodiment, when the regional focus element is in the second state corresponding to being in the intermediate range of focus distance, it may include a corresponding graphical focus indicator (e.g., a single arrow), and a user may right click or double click on the regional focus element (e.g., on the graphical focus indicator) to activate operations that move toward the focus height by the second-state predetermined step size, and then immediately automatically move to the focus height based on acquiring and analyzing an image stack. Such an autofocus operation may be quick and accurate, since it does not require the user to access a separate tool and/or redefine the region of interest, and the Z height range for the image stack may be small and well defined (requiring relatively few images to be acquired and analyzed), because the predetermined step size that precedes the autofocus operation substantially and rapidly diminishes the required focus distance.

In one embodiment, a third state of a regional focus element may include a third-state set of focus operations that are activated when a user uses an input device to activate the regional focus element in a way that corresponds to the third-state set of focus operations. In one embodiment, the third-state set of focus operations includes operations that move toward the focus height by a predetermined step size that is larger than the second-state predetermined step size when activated by user input. For example, in one specific embodiment, when the regional focus element is in the third state corresponding to being in the far range of focus distance, it may include a corresponding graphical focus indicator (e.g., a double arrow), and a user may single click on the regional focus element (e.g., on the graphical focus indicator) to activate an operation that moves toward the focus height by a predetermined step size (e.g., a predetermined step size that is larger than the second-state predetermined step size, such as three or five times the depth of field of the imaging system, or one quarter of the far range limit, or the like, in some embodiments). This allows the user to rapidly (and repeatedly, if desired) jog the focus by a useful amount relative to the region surrounding the particular regional focus element that is activated. In one embodiment, the third state of a regional focus element may further include an extended third-state set of focus operations that are activated when a user uses an input device to activate the regional focus element in a way that corresponds to the extended third-state set of focus operations. In one embodiment, the extended third-state set of focus operations includes executing the foregoing third-state set of focus operations, immediately and automatically followed by autofocus operations that move to the focus height based on acquiring and analyzing an image stack, when activated by an appropriate user input. For example, in one specific embodiment, when the regional focus element is in the third state corresponding to being in the far range of focus distance, it may include a corresponding graphical focus indicator (e.g., a double arrow), and a user may right click or double click on the regional focus element (e.g., on the graphical focus indicator) to activate operations that move toward the focus height by the third-state predetermined step size, and then immediately automatically move to the focus height based on acquiring and analyzing an image stack. Such an autofocus operation may be quick and accurate, since it does not require the user to access a separate tool and/or redefine the region of interest, and the Z height range for the image stack may be small and well defined (requiring relatively few images to be acquired and analyzed), because the predetermined step size that precedes the autofocus operation substantially and rapidly diminishes the required focus distance.

In certain cases, it may be difficult to estimate the focus distance reliably, in which case more qualitative definitions may be applied. For example, the far range may correspond to a distance or condition at which an autofocus process is likely to fail, and the close range may correspond to a distance at which there is a high degree of certainty that an autofocus process will be successful. This might be indicated by the amount of data in a focus curve, or the height or noise of the data in a focus curve, or the like. Such indicators may be useful in embodiments where an operator is given the option of selecting (e.g., with a double mouse click) whether or not an autofocus process will automatically be run, either at the present distance or else after a predetermined distance has been moved toward the desired focus.

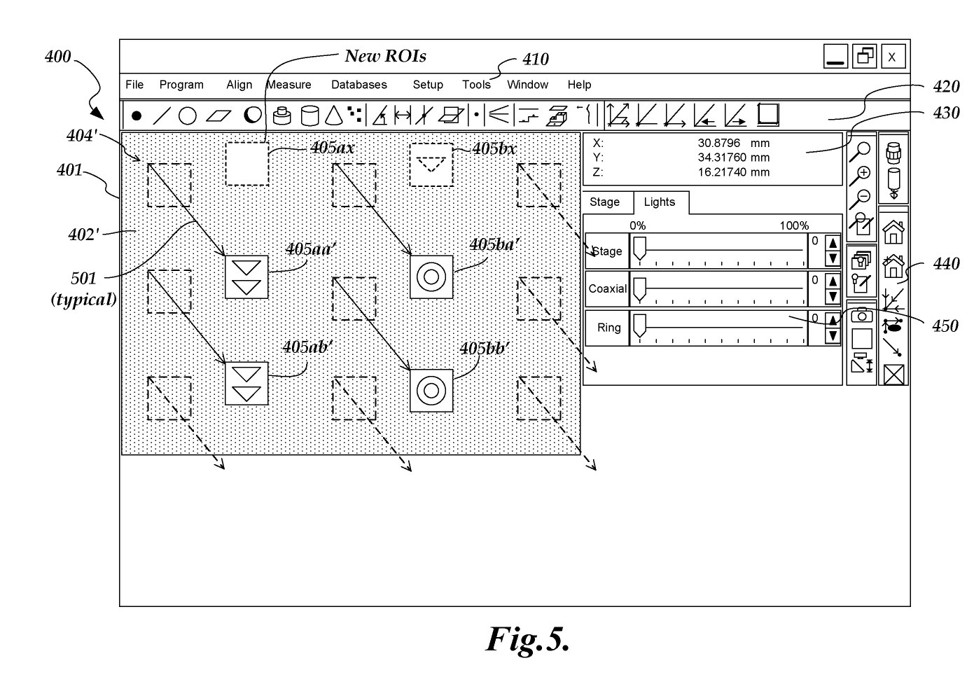

FIG. 5 is a diagram illustrating the user interface display 400 of FIG. 4 after a stage movement has shifted the location of the workpiece, such that a new portion of the workpiece is in the imaged and displayed field of view. Such shifts in location may occur for various reasons (e.g., a user moving the camera in the XY direction to locate additional features to be inspected, etc.). In the exemplary state shown in FIG. 5, the user interface display 400 includes the field of view window 401 shown in FIG. 3, displaying a shifted workpiece image 402′ and a multi-region focus navigation interface 404′ which shows regional focus elements 405aa′, 405ab′, 405ba′, and 405bb′, which are shifted instances of the regional focus elements 405aa, 405ab, 405ba, and 405bb shown in FIG. 3, by amounts corresponding to the motion arrow 501.

As will be described in more detail below, the multi-region focus navigation interface 404′ is configured such that after the field of view 401 has been moved relative to the workpiece surface, each regional focus element is moved relative to the image of the field of view 401 such that it follows its corresponding region of interest in the image of the field of view and thus remains positioned superimposed over the same portions of the workpiece surface. In the new location, the regions of interest corresponding to the regional focus elements 405ac, 405bc, 405ca, 405cb, and 405cc are no longer in the field of view window 401, and so are not shown. Furthermore, in one embodiment, when the field of view 401 is moved, additional regional focus elements may be added to the field of view 401. Thus, two new regional focus elements 405ax and 405bx are also shown in the field of view window 401. The new regional focus elements may be automatically generated corresponding to regions of interest at a default or predetermined spacing relative to previously defined regional focus elements. New regional focus elements may be blank, until sufficient corresponding focus curve data is determined.

When a shift in position occurs, in one embodiment it is desirable to monitor any lighting change that occurs with regard to the move (e.g., lighting is often adjusted after a new field of view is roughly in focus). In certain implementations, it may be desirable to normalize image intensity values so that the sampled contrast values are relatively insensitive to lighting change, preserving the ability to meaningfully combine focus curve data obtained before, during, and after moves.

In some implementations, the stage speed may vary significantly during the manual focus, which may introduce different amount of motion blur at each Z position, adding significant variation to the sampled contrast values. One technique for addressing this issue, at least in part, is to record the stage speed with each image, so as to be able to at least partially compensate the contrast value based on the stage speed. Alternatively, if the stage speed can not be returned with each image, then it may be desirable to allow extra margins for noise when processing the contrast data.

It should be appreciated that the embodiment shown in FIG. 5 is exemplary and not limiting. For example, in alternative embodiments, when a shift in position occurs, the regional focus elements 405aa, 405ab, 405ba, and 405bb may be fixed relative to the field of view window 401 rather than remaining positioned superimposed over the same portions of the workpiece surface.

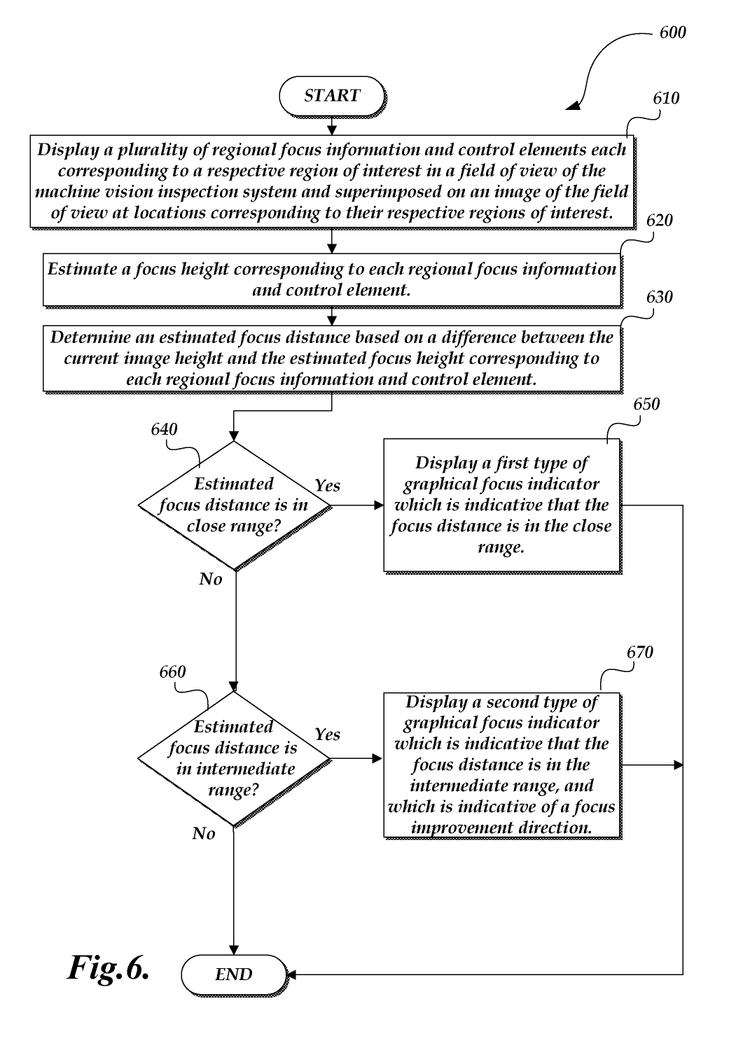

FIG. 6 is a flow diagram illustrating one embodiment of a general routine 600 for operating a multi-region focus navigation interface for a machine vision inspection system. At a block 610, a plurality of regional focus elements are displayed, each corresponding to a respective region of interest in a field of view of the machine vision inspection system and superimposed on an image of the field of view at locations corresponding to their respective regions of interest (e.g., see regional focus elements 405aa-405cc of FIG. 4). At a block 620, a focus height is estimated corresponding to each regional focus element (e.g., based on “invisibly” acquiring images during ordinary user-direction movement and operations and analyzing the images for focus curve data). At a block 630, an estimated focus distance is determined for the regional focus elements based on a difference between the current image height and the estimated focus height corresponding to each regional focus element.

At a decision block 640, a determination is made as to whether the estimated focus distance is in a close range. If the estimated focus distance is not in a close range, then the routine continues to a decision block 660, as will be described in more detail below. If the estimated focus distance is in a close range, then the routine continues to a block 650, where a first type of graphical focus indicator is displayed which is indicative that the focus distance is in the close range (e.g., see regional focus elements 405ba and 405bb of FIG. 4).

At the decision block 660, a determination is made as to whether the estimated focus distance is in an intermediate range. If the estimated focus distance is not in an intermediate range, then the routine ends. If the estimated focus distance is in an intermediate range, then the routine continues to a block 670, where a second type of graphical focus indicator is displayed which is indicative that the focus distance is in the intermediate range, wherein the second graphical focus indicator is also indicative of a focus improvement direction (e.g., see regional focus elements 405ac, 405bc, and 405cc of FIG. 4).

It will be appreciated that for purposes of simplicity the routine 600 is shown as only evaluating for two ranges of the estimated focus distance. However, in certain embodiments, more ranges may be implemented (e.g., the far range of FIGS. 3, 4, and 5, for which a third type of graphical focus indicator would be displayed, such as are shown in the regional focus elements 405aa, 405ab, 405cb, and 405cc of FIG. 4, etc.). Furthermore, it will also be appreciated that when the estimated focus distance does not fall into any of the specified ranges, this may indicate that the system is uncertain of the estimated range, in which case no graphical focus indicator may be displayed (e.g., see regional focus element 405ca of FIG. 4).

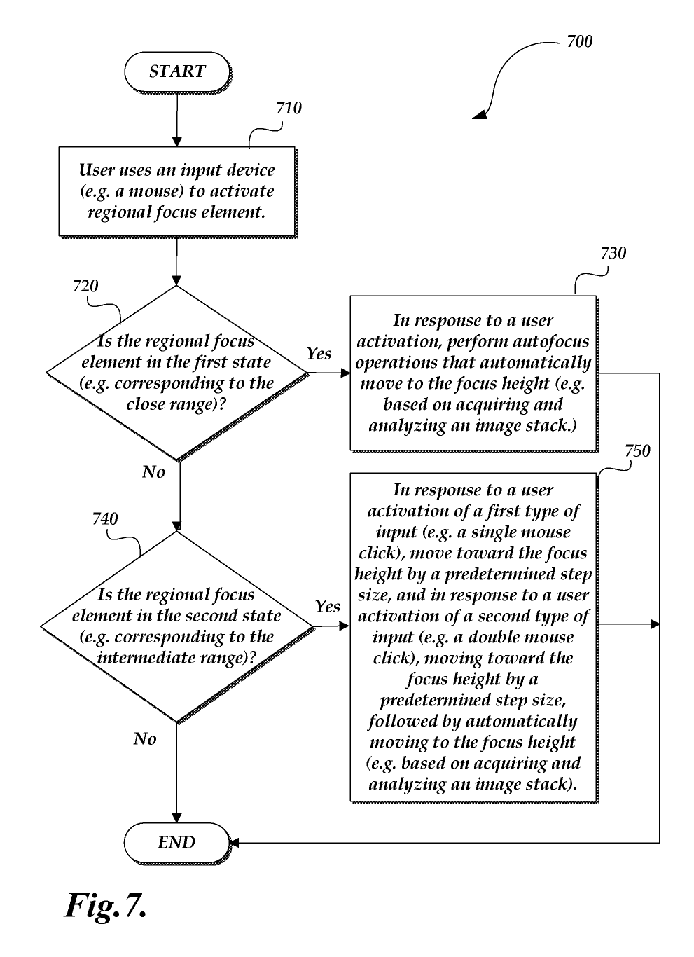

FIG. 7 is a flow diagram illustrating one embodiment of a general routine 700 for implementing focus control operations associated with the operation of regional focus elements in a multi-region focus navigation interface for a machine vision inspection system. At a block 710, a user uses an input device (e.g., a mouse) to activate a regional focus element. At a decision block 720, a determination is made as to whether the regional focus element is in the first state (e.g., corresponding to its focus distance being in the close range, as outlined above). If the regional focus element is not in the first state, then the routine continues to a decision block 740, as will be described in more detail below. If the regional focus element is in the first state, then the routine continues to a block 730. At the block 730, provided that the user activation was of the corresponding type, then autofocus operations are performed that automatically move to the focus height (e.g., based on acquiring and analyzing an image stack).

At the decision block 740, a determination is made as to whether the regional focus element is in the second state (e.g., corresponding to its focus distance being in the intermediate range, as outlined above). If the regional focus element is not in the second state, then the routine ends. If the regional focus element is in the second state, then the routine continues to a block 750. At the block 750, provided that the user activation corresponded to a first type of input (e.g., a single or left mouse click, or the like), the machine vision system is controlled such that the image height is moved toward the focus height by a predetermined step size. Alternatively, provided that the user activation corresponded to a second type of input (e.g., a double or right mouse click, or the like), the machine vision system is controlled such that the image height is moved toward the focus height by a predetermined step size, immediately followed by automatically moving to the focus height (e.g., based on acquiring and analyzing an image stack).

As noted above with respect to FIG. 6, in other implementations other operating states and ranges may also be implemented with other associated types of graphical focus indicators (e.g., a third type of graphical focus indicator associated with the far range, etc.). Such additional operating states may correspond to additional control operations (e.g., the third type of graphical focus indicator, and third-state control operations that in one embodiment are substantially similar to those corresponding to the second operating state, with the exception of the predetermined step size being larger for the control operations corresponding to the third operating state, etc.).

While the preferred embodiment of the invention has been illustrated and described, numerous variations in the illustrated and described arrangements of features and sequences of operations will be apparent to one skilled in the art based on this disclosure. Thus, it will be appreciated that various changes can be made therein without departing from the spirit and scope of the invention.

The embodiments of the invention in which an exclusive property or privilege is claimed are defined as follows:

1. A multi-region focus navigation interface for a machine vision inspection system which comprises a control system, an imaging system, a display and a user interface, the multi-region focus navigation interface comprising:
a plurality of regional focus elements each corresponding to a respective region of interest in a field of view of the machine vision inspection system and superimposed on an image of the field of view,
wherein:
the plurality of regional focus elements are simultaneously displayed on the image of the field of view at locations corresponding to their respective regions of interest;
each regional focus element comprises a graphical focus indicator which is indicative of a focus distance for the current image height relative to a focus height corresponding to its respective region of interest on the workpiece surface;
each regional focus element comprises at least a first operating state corresponding to the focus distance being in a close range, and a second operating state corresponding to the focus distance being in an intermediate range that extends farther from the focus height than the close range;
the first operating state comprises a first type of graphical focus indicator which is indicative that the focus distance is in the close range; and
the second operating state comprises a second type of graphical focus indicator which is indicative that the focus distance is in the intermediate range, wherein the second graphical focus indicator is also indicative of a focus improvement direction.

2. The multi-region focus navigation interface of claim 1, wherein the first operating state further comprises a first-state set of focus operations that are activated when a user uses an input device to provide a corresponding activation of the focus element during the first operating state, the first-state set of focus operations comprising autofocus operations that automatically move to the focus height based on acquiring and analyzing an image stack.

3. The multi-region focus navigation interface of claim 1, wherein the second operating state further comprises a second-state set of focus operations that are activated when a user uses an input device to provide a corresponding activation of the focus element during the second operating state, the second-state set of focus operations comprising operations that move toward the focus height by a predetermined step size.

4. The multi-region focus navigation interface of claim 3, wherein the second operating state further comprises an extended second-state set of focus operations that are activated when a user uses an input device to provide a corresponding activation of the focus element during the second operating state, the extended second-state set of focus operations comprising operations that move toward the focus height by a predetermined step size followed by autofocus operations that automatically move to the focus height based on acquiring and analyzing an image stack.

5. The multi-region focus navigation interface of claim 4, wherein the second-state set of focus operations are activated by a first type of user input device activation, and the extended second-state set of focus operations are activated by a second type of user input device activation.

6. The multi-region focus navigation interface of claim 1, wherein each regional focus element is configured to be activated by the user positioning a cursor of the multi-region focus navigation interface proximate to the corresponding graphical focus indicator and entering an activation signal using the input device.

7. The multi-region focus navigation interface of claim 6, wherein the activation signal is a mouse click.

8. The multi-region focus navigation interface of claim 1, wherein:
each regional focus element comprises a third operating state corresponding to the focus distance being in a far range that extends farther from the focus height than the intermediate range; and
the third operating state comprises a third type of graphical focus indicator which is indicative of the focus improvement direction and that the focus distance is in the far range.

9. The multi-region focus navigation interface of claim 8, wherein the third operating state further comprises a third-state set of focus operations that are activated when a user uses an input device to provide a corresponding activation of the focus element during the third operating state, the third-state set of focus operations comprising operations that move toward the focus height by a predetermined step size.

10. The multi-region focus navigation interface of claim 9, wherein the third operating state further comprises an extended third-state set of focus operations that are activated when a user uses an input device to provide a corresponding activation of the focus element during the third operating state, the extended third-state set of focus operations comprising operations that move toward the focus height by a predetermined step size followed by autofocus operations that automatically move to the focus height based on acquiring and analyzing an image stack.

11. The multi-region focus navigation interface of claim 10, wherein the third-state set of focus operations are activated by a first type of user input device activation, and the extended third-state set of focus operations are activated by a second type of user input device activation.

12. The multi-region focus navigation interface of claim 1, wherein the plurality of regional focus elements comprises at least three regional focus elements spaced apart along a first direction.

13. The multi-region focus navigation interface of claim 12, wherein the plurality of regional focus elements comprises at least three regional focus elements spaced apart along a second direction that is transverse to the first direction.

14. The multi-region focus navigation interface of claim 1, wherein the second type of graphical focus indicator comprises an arrow which is oriented to indicate the focus improvement direction.

15. The multi-region focus navigation interface of claim 1, wherein the multi-region focus navigation interface is configured such that when the field of view is moved relative to a workpiece surface, each regional focus element is moved to follow its corresponding region of interest in the image of the field of view.

16. The multi-region focus navigation interface of claim 15, wherein the multi-region focus navigation interface is configured such that when the field of view is moved by a sufficient distance, a new regional focus element is automatically generated for the plurality of regional focus elements, the new regional focus element corresponding to a new region of interest in the image of the field of view.

17. The multi-region focus navigation interface of claim 1, wherein the regional focus elements are configured to include operations comprising at least one of:
(a) operations responsive to user input for changing the location of a regional focus element and its corresponding region of interest relative to the image of the field of view; and
(b) operations responsive to user input for eliminating a regional focus element from an image of the field of view.

18. A method for operating a multi-region focus navigation interface of a machine vision inspection system which comprises a control system, an imaging system, a display and a user interface, the method comprising:
displaying a plurality of regional focus elements each corresponding to a respective region of interest in a field of view of the machine vision inspection system and superimposed on an image of the field of view at locations corresponding to their respective regions of interest;
determining a focus distance corresponding to each regional focus element;
displaying a graphical focus indicator in each regional focus element which is indicative of a focus distance for the current image height relative to a focus height corresponding to its respective region of interest on the workpiece surface;
operating each regional focus element differently, depending on its corresponding focus distance according to one of a set of operating states, the set of operating states comprising at least a first operating state corresponding to the focus distance being in a close range, and a second operating state corresponding to the focus distance being in an intermediate range that extends farther from the focus height than the close range;
when a regional focus element is in a first operating state, displaying a first type of graphical focus indicator which is indicative that the focus distance is in the close range; and
when a regional focus element is in a second operating state, displaying a second type of graphical focus indicator which is indicative that the focus distance is in the intermediate range, wherein the second graphical focus indicator is also indicative of a focus improvement direction.

19. The method of claim 18, wherein when a regional focus element is in the first operating state, further performing a first-state set of focus operations that are activated when a user uses an input device to provide a corresponding activation of the regional focus element, the first-state set of focus operations comprising autofocus operations that automatically move to the focus height based on acquiring and analyzing an image stack.

20. The method of claim 18, wherein when a regional focus element is in the second operating state, further performing one of a second-state set of focus operations and an extended second-state set of focus operations depending on which one of a first type and a second type of user input device activation of the regional focus element is provided by a user during the second operating state, the second-state set of focus operations comprising operations that move toward the focus height by a predetermined step size in response to the first type of user input device activation, and the extended second-state set of focus operations comprising operations that move toward the focus height by a predetermined step size followed by autofocus operations that automatically move to the focus height based on acquiring and analyzing an image stack in response to the second type of user input device activation.
